(19) United States
(12) Patent Application Publication
(10) Pub. No.: US 2025/0138860 A1
(43) Pub. Date: May 1, 2025

(54) METHOD, APPARATUS, ELECTRONIC DEVICE AND STORAGE MEDIUM FOR CONTROLLING A VIRTUAL MACHINE

(71) Applicant: Beijing Volcano Engine Technology Co., Ltd., Beijing (CN)

(72) Inventors: Shenming LU, Beijing (CN); Zhe Li, Beijing (CN); Yibo Zhou, Beijing (CN); Jian Wang, Beijing (CN)

(21) Appl. No.: 18/770,535

(22) Filed: Jul. 11, 2024

(30) Foreign Application Priority Data
Oct. 30, 2023 (CN) 202311423839.1

(51) Int. Cl. G06F 9/455

(52) U.S. Cl. CPC G06F 9/45558; G06F 2009/45587

(57) ABSTRACT

The embodiment of the disclosure provides a method, apparatus, electronic device and storage medium for controlling a virtual machine. The method includes: obtaining, during a physical machine starting process, processor configuration information of the physical machine from a memory of the physical machine, the processor configuration information indicating a to-be-configured processor in the physical machine, and the to-be-configured processor being a physical processor bound to a virtual processor of a virtual machine; determining the to-be-configured processor based on the processor configuration information; and configuring the to-be-configured processor into a first state, when being in the first state, the to-be-configured processor being isolated from the physical machine and supporting an invocation by a virtual machine in the physical machine. By utilizing the above technical scheme of embodiments of this disclosure, the data processing speed of the virtual machine can be improved, and the performance of the virtual machine is improved.

### CROSS-REFERENCE

The present application claims priority to Chinese Patent Application No. 202311423839.1, filed on Oct. 10, 2023 and entitled “METHOD, APPARATUS, ELECTRONIC DEVICE AND STORAGE MEDIUM FOR CONTROLLING A VIRTUAL MACHINE”, the entirety of which is incorporated herein by reference.

### FIELD

The embodiments of this disclosure relate to the field of computer technologies, and in particular, to a method, an apparatus, an electronic device, and a storage medium for controlling a virtual machine.

### BACKGROUND

In a cloud computing or virtual machine application scenario, a virtualization technology may be used to simulate a computer system having a complete hardware system function and run in an isolated environment through software on a physical machine, that is, a virtual machine is provided for a user. Because the virtual machine needs to simulate the underlying hardware instructions, the running speed of the application program in the virtual machine during actual operation is significantly slower than that of the application program running on the physical machine. Therefore, it is a problem needs to be solved in the cloud computing scenario that how to improve the data processing speed of the virtual machine to reduce the cloud cost of the service.

### SUMMARY

The embodiment of this disclosure provides a method, an apparatus, an electronic device and a storage medium for controlling a virtual machine, to improve the data processing speed of the virtual machine.

In the first aspect, the embodiment of the disclosure provides a method of controlling a virtual machine, comprising:
obtaining, during a physical machine starting process, processor configuration information of the physical machine from a memory of the physical machine, the processor configuration information indicating a to-be-configured processor in the physical machine, and the to-be-configured processor being a physical processor bound to a virtual processor of a virtual machine:
determining the to-be-configured processor based on the processor configuration information: and
configuring the to-be-configured processor into a first state, when being in the first state, the to-be-configured processor being isolated from the physical machine and supporting an invocation by a virtual machine in the physical machine.

In the second aspect, the embodiment of the disclosure provides an apparatus for controlling a virtual machine, comprising:
an information obtaining module configured to obtain, during a physical machine starting process, processor configuration information of the physical machine from a memory of the physical machine, the processor configuration information indicating a to-be-configured processor in the physical machine, and the to-be-configured processor being a physical processor bound to a virtual processor of a virtual machine:
a first determination module configured to determine the to-be-configured processor based on the processor configuration information; and
a processor configuring module configured to configure the to-be-configured processor into a first state, when being in the first state, the to-be-configured processor being isolated from the physical machine and supporting an invocation by a virtual machine in the physical machine.

In the third aspect, the embodiment of this disclosure provides an electronic device, comprising:
one or more processors; and
a memory storing one or more programs:
the one or more programs, when executed by the one or more processor, causing the one or more processor to perform the method of controlling a virtual machine according to the embodiments of the disclosure.

In the fourth aspect, the embodiment of this disclosure provides a computer-readable storage medium storing computer instructions which, when executed by a processor, implement the method of controlling a virtual machine according to the embodiments of the disclosure.

According to the method, the apparatus, the electronic device and the storage medium for controlling a virtual machine provided by the embodiments of the disclosure, during a physical machine starting process, processor configuration information of the physical machine is obtained from a memory of the physical machine. The processor configuration information indicates a to-be-configured processor in the physical machine, and the to-be-configured processor is a physical processor bound to a virtual processor of a virtual machine. The to-be-configured processor is determined based on the processor configuration information. The to-be-configured processor is configured into a first state, when being in the first state, the to-be-configured processor is isolated from the physical machine and supports an invocation by a virtual machine in the physical machine. With the above technical solution, the virtual machine is supported to directly invoke the physical processor in the physical machine to perform data processing, without invoking the software in the physical machine to simulate. Therefore, the data processing speed of the virtual machine may be increased and the performance of the virtual machine may be improved.

### BRIEF DESCRIPTION OF DRAWINGS

The above and other features, advantages, and aspects of various embodiments of the disclosure will become more apparent from the following detailed description taken in conjunction with the accompanying drawings. Throughout the drawings, the same or similar reference numbers refer to the same or similar elements. It should be understood that the drawings are schematic, and elements and components are not necessarily drawn to scale.

FIG. 1 is a schematic flowchart of a method of controlling a virtual machine according to an embodiment of the present disclosure;

FIG. 2 is a schematic structural diagram of a physical machine and a virtual machine according to an embodiment of the present disclosure:

FIG. 3 is a schematic flowchart of another method of controlling a virtual machine according to an embodiment of the present disclosure:

FIG. 4 is a structural block diagram of an apparatus for controlling a virtual machine according to an embodiment of the present disclosure; and

FIG. 5 is a schematic structural diagram of an electronic device according to an embodiment of the present disclosure.

### DETAILED DESCRIPTION

The embodiments of the present disclosure will be described in more detail below with reference to the accompanying drawings. While certain embodiments of the present disclosure are shown in the drawings, it is to be understood that the present disclosure may be implemented in various forms, and should not be construed as limited to the embodiments set forth herein. Rather, these embodiments are provided for a more thorough and complete understanding of the present disclosure. It should be understood that the drawings and embodiments of the present disclosure are for exemplary purposes only and are not intended to limit the scope of the present disclosure.

It should be understood that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “comprise” and variation thereof are open-ended, i.e., “comprise but not limited to”. The term “based on” is “based at least in part on”. The term “one embodiment” means “at least one embodiment”; the term “another embodiment” means “at least one further embodiment”; and the term “some embodiments” means “at least some embodiments”. The relevant definition of other terms will be given below.

It should be noted that words such as “first” and “second” mentioned in this disclosure are merely used to distinguish different apparatuses, modules, or units, and are not intended to limit the order of functions performed by the apparatuses, modules, or units or the mutual dependency.

It should be noted that the modification of “a” and “a plurality” mentioned in this disclosure is illustrative and not limiting, and those skilled in the art should understand that “one or more” should be understood unless the context clearly indicates otherwise.

The names of messages or information interacted between a plurality of devices in implementations of the disclosure are for illustrative purposes only and are not intended to limit the scope of such messages or information.

It can be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal information of the user. Therefore, the user may autonomously select whether to provide personal information to software or hardware executing the operations of the technical solution of the present disclosure according to the prompt information, such as electronic device, application program, server or storage medium.

As an optional but non-limiting implementation, in response to receiving the active request of the user, the manner of sending the prompt information to the user may be, for example, a pop-up window, and the prompt information may be presented in a text in the pop-up window. In addition, the pop-up window may further carry a selection control for the user to select “agree” or “disagree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

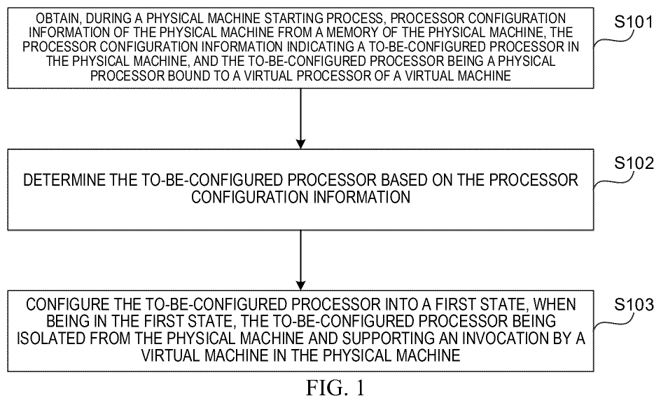

FIG. 1 is a schematic flowchart of a method for controlling a virtual machine according to an embodiment of the disclosure. The method may be performed by an apparatus for controlling a virtual machine, where the apparatus may be implemented by software and/or hardware, may be configured in an electronic device, typically in a physical machine. The method of controlling a virtual machine provided in the embodiments of the present disclosure is applicable to a scenario in which a physical processor in a physical machine is configured.

Compared with a physical machine, a virtual machine brings some flexibility to the business, but also bring some performance losses, that is, the service performance is reduced. A reason for causing a decrease in service performance in a virtualization scenario is mainly from two aspects: a physical central processing unit (PCPU) used by a virtual central processing unit (VCPU) also runs some tasks with a higher priority than a VCPU thread, such as a soft interrupt and a work queue, which is easily interfered by a physical machine and causes performance degradation: in order to isolate a virtual machine from a physical machine, access to many privilege registers and instructions will be trapped, thereby affecting the performance of the virtual machine, and the programming of a local advanced programmable interrupt controller (LAPIC) register (Model Specific Register. MSR), such as an advanced programmable interrupt controller (APIC) timer, an intelligent character recognition (ICR), etc., causes a lot of traps because it is in a hot path, which is critical to the performance of the virtual machine.

Taking the commonly used advertisement/recommendation service as an example, since their service mode is multi-thread and there are more shared memory used among threads, this results in a large number of timers and translation lookaside buffer (TLB) flushing. These manifestations at the virtualization overhead level are a significant amount of inter-kernel communication (primarily write interrupt control registers) and write TSCDEADLINE registers and external interrupt exit.

For the foregoing actual service problem, the existing optimization solutions mainly comprise: an inter-kernel communication pass through and a timer pass through optimization solution, but these are single-point optimization solutions or have an invasive modification to a virtual machine. There are also some systematic solutions in the industry, but related limitations are summarized mainly in the following two aspects: in order to achieve high performance, all isolation of complete bypass virtualization leads to a large security risk: poor compatibility with the current virtualization ecology, for example, it cannot be well supported in terms of hot upgrade and hot migration, and a large number of modified virtual machines and physical machine kernel are required.

Therefore, embodiments of the present disclosure provide a method for controlling a virtual machine, to systematically optimize virtualization overheads while ensuring security isolation, improve performance, and may be compatible with existing virtualization frameworks such as libvirt, qemu, and kvm.

As shown in FIG. 1, the method of controlling a virtual machine provided in this embodiment may comprise:

S101, obtaining, during a physical machine starting process, processor configuration information of the physical machine from a memory of the physical machine, the processor configuration information indicating a to-be-configured processor in the physical machine, and the to-be-configured processor being a physical processor bound to a virtual processor of a virtual machine.

The processor configuration information may be configuration information used to indicate a to-be-configured processor in the physical machine, and may be set in advance. For example, the processor configuration information may be related information of a physical processor that needs to be configured into a first state, for example, identification information of a physical processor. The to-be-configured processor may be understood as a processor that may be configured as being dedicated to the virtual machine (that is, a first state), and may be a physical processor in a physical machine bound to a virtual processor of a virtual machine, for example, a central processing unit (CPU) bound to a virtual processor of a virtual machine in a physical machine. The following uses a to-be-configured processor as a physical CPU as an example for description.

In this embodiment, the developer may predetermine a physical processor dedicated to the virtual machine in the physical machine. For example, the processor information of the physical processor dedicated to the virtual machine may be recorded in the processor configuration information of the physical machine. Therefore, during the startup process of the physical machine, the processor configuration information stored in the memory of the physical machine may be obtained, so that the physical processor that may be set to be dedicated to the virtual machine may be determined based on the processor configuration information of the physical machine.

S102: determining the to-be-configured processor based on the processor configuration information.

In this embodiment, the developer may pre-configure and store, in the memory of the physical machine, the processor configuration information of the to-be-configured processor that may be set to be dedicated to the virtual machine. Therefore, after obtaining the processor configuration information of the physical machine, the to-be-configured processor in the physical machine may be determined based on the processor configuration information. For example, the processor information of the to-be-configured processor recorded in the processor configuration information is obtained, and the physical processor corresponding to the processor information in the physical machine is determined as the to-be-configured processor.

S103: configuring the to-be-configured processor into a first state, when being in the first state, the to-be-configured processor being isolated from the physical machine and supporting an invocation by a virtual machine in the physical machine.

The first state may be a predetermined state of the to-be-configured processor, and the to-be-configured processor in the predetermined state is isolated from the physical machine and supports an invocation by a virtual machine in the physical machine. The isolation between the to-be-configured processor and the physical machine may be understood as that when the to-be-configured processor is in the predetermined state, the physical machine does not invoke the to-be-configured processor to perform data processing, for example, the to-be-configured processor is invisible to the scheduler on the physical machine. It may be understood that the to-be-configured processor has not been isolated from the virtual machine in the physical machine. The support of an invocation by a virtual machine in the physical machine may be understood as: when the to-be-configured processor is in the predetermined state, the virtual machine in the physical machine may directly invoke the to-be-configured processor to perform data processing, and when the to-be-configured processor is directly invoked to perform data processing, the virtual machine does not need to invoke the software installed in the physical machine to simulate by the software installed in the physical machine.

It should be noted that the virtual machine in the physical machine may directly invoke the to-be-configured processor to perform data processing, which does not mean that the virtual machine may only directly invoke the to-be-configured processor to perform data processing, and in a case that there is a requirement for simulation by using the software in the physical machine, the virtual machine in the physical machine still may perform data processing by the way of simulation by using the software installed in the physical machine.

For example, after determining the to-be-configured processor in the physical machine, the to-be-configured processor in the physical machine may be configured into the first state, for example, the to-be-configured processor in the physical machine is isolated from the physical machine, and the to-be-configured processor in the physical machine is configured into a state in which the invocation by a virtual machine in the physical machine is supported.

In this embodiment, the manner in which the to-be-configured processor is configured into the first state may be set as needed. For example, existing or non-existing technologies may be used to isolate the to-be-configured processor in the physical machine from the physical machine, and/or, the to-be-configured processor in the physical machine may be configured into a state in which the invocation by a virtual machine in the physical machine is supported.

In some implementations, configuring the to-be-configured processor into a first state comprises: taking the to-be-configured processor offline; and controlling, according to virtual machine configuration information stored in the memory of the physical machine, the offline to-be-configured processor to perform initialization to configure the to-be-configured processor into the first state, the offline to-be-configured processor being not registered with a scheduler of the physical machine during initialization.

In the foregoing implementation, the to-be-configured processor may be configured into the first state by taking the to-be-configured processor offline and controlling, according to virtual machine configuration information, the to-be-configured processor to perform initialization.

Specifically: the to-be-configured processor may firstly be controlled to go offline. Then, the function supported by the virtual machine is determined according to the virtual machine configuration information stored in the memory of the physical machine. Further, the processor resources need to be initialized is determined according to the function supported by the virtual machine, and the processor resources in the to-be-configured processor is initialization. The virtual machine configuration information may be understood as configuration information of the virtual machine. The processor resources that need to be initialized by the to-be-configured processor may be a processor resources that may be used by the virtual machine in the operation process, for example, a processor resource associated with a function of the virtual machine.

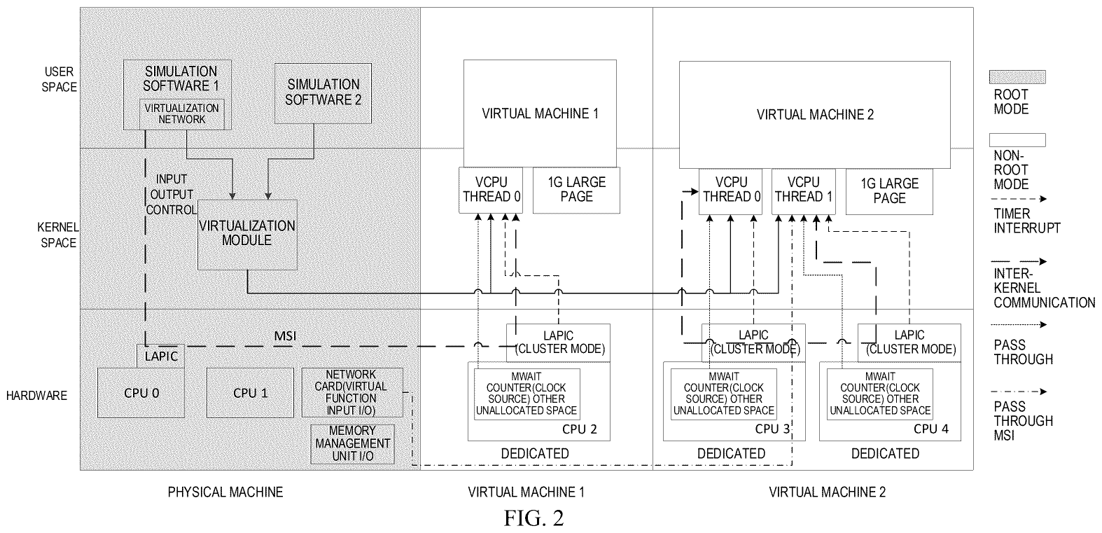

In some optional implementations, as shown in FIG. 2 (an example in which two virtual machines are configured in a physical machine as an example), a strong isolation framework may be established. A PCPU bound to a VCPU is isolated from a physical machine system, for example, a CPU is taken offline first, and then boot the PCPU dedicated for a VCPU, that is, boot to be in a first state. At this time, the PCPU only has a basic environment required by a VCPU thread to operate, and shields an interrupt response at a physical machine side thereof.

For example, the to-be-configured processor may be configured into the first state in the following manner:

During a physical machine starting, for example, during a process of loading a boot file in a physical machine, the CPUs other than a CPU to be reserved for a control panel or another application program, for example, a CPU bound to a virtual processor of a virtual machine (that is, a to-be-configured processor), may be configured as being dedicated for the VCPU. That is, the CPUs do not initialize any kernel threads, variables and work queues that are not associated with running the vCPU, and meanwhile, the scheduler on the physical machine cannot see these CPUs.

Taking virtual machine interrupt optimization as an example, a root of traditional virtualization overheads is that there is only one interrupt delivery path on hardware. If both the physical machine and the virtual machine send interrupts directly through the physical APIC, these interrupts may be blended and cannot be distinguished from which are delivered to the physical machine and which are delivered to the virtual machine, and therefore must be involved by a management program (such as Hypervisor). In addition, considering the elimination of interference on the host side, for example, on the premise that the VCPU is bound to the PCPU one by one, the PCPUs bound to the VCPU may be selected from the physical system as much as possible. The specific implementation for example may be, taking CPU (i.e., the to-be-configured processor) offline, and initializing it to be dedicated for VCPU, for example, only having the basic environment required by VCPU thread to operate and shielding its interrupt response on the physical machine side. On this basis, the physical CPU and LAPIC may be handed over to virtual machine to control to a large extent. The virtual machine may directly use physical LAPIC to send and receive interrupt instructions without virtualization exit.

In the method of controlling a virtual machine provided in this embodiment, during the physical machine starting process, processor configuration information of the physical machine may be obtained from a memory of the physical machine, wherein the processor configuration information indicates a to-be-configured processor in the physical machine, and the to-be-configured processor is a physical processor bound to a virtual processor of a virtual machine. The to-be-configured processor is determined based on the processor configuration information. The to-be-configured processor is configured into a first state, when being in the first state, the to-be-configured processor is isolated from the physical machine and supports an invocation by a virtual machine in the physical machine. With the above solution of the embodiment. (a part of the physical processor in the physical machine is configured into a state in which it is isolated from the physical machine and supports the invocation by the virtual machine in the physical machine, so that the virtual machine may directly invoke the configured physical processor for data processing without simulation by software in the physical machine, thus improving the data processing speed of the virtual machine and improving the performance of the virtual machine.

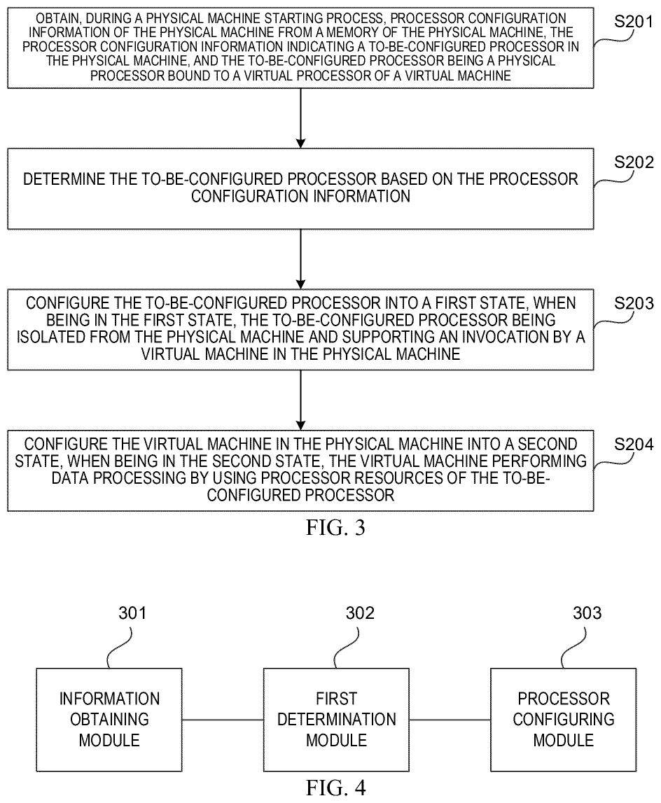

FIG. 3 is a schematic flowchart of another method of controlling a virtual machine according to an embodiment of the present disclosure. The solution in this embodiment may be combined with one or more optional solutions in the foregoing embodiment. Optionally, the method further comprises, after configuring the to-be-configured processor into the first state: configuring the virtual machine in the physical machine into a second state, when being in the second state, the virtual machine performing data processing by using processor resources of the to-be-configured processor.

Correspondingly, as shown in FIG. 3, the method of controlling a virtual machine provided in this embodiment may comprise:

S201, obtaining, during a physical machine starting process, processor configuration information of the physical machine from a memory of the physical machine, the processor configuration information indicating a to-be-configured processor in the physical machine, and the to-be-configured processor being a physical processor bound to a virtual processor of a virtual machine.

S202, determining the to-be-configured processor based on the processor configuration information.

S203, configuring the to-be-configured processor into a first state, when being in the first state, the to-be-configured processor being isolated from the physical machine and supporting an invocation by a virtual machine in the physical machine.

S204, configuring the virtual machine in the physical machine into a second state, when being in the second state, the virtual machine performing data processing by using processor resources of the to-be-configured processor.

The second state may be a certain set state of the virtual machine, and the virtual machine in the set state may directly perform data processing through the processor resources of the to-be-configured processor, without simulation by using software in the physical machine. The processor resources of a processor (for example, a to-be-configured processor) may be a processing resources in the processor. Optionally, the processor resources comprise at least one of a register, a predetermined instruction, and an interrupt controller. Therefore, after configuring into the second state, the virtual machine may directly invoke a register, a predetermined instruction, and/or an interrupt controller in the to-be-configured processor for data processing. The register, the predetermined instruction, and the interrupt controller in the to-be-configured processor may be configured as need, which is not limited in this embodiment. For example, the predetermined instruction may comprise an instruction such as a pause instruction HLT and/or a thread synchronization instruction MWAIT; and the interrupt controller may comprise an interrupt controller such as an LAPIC or a peripheral.

In this embodiment, after the to-be-configured processor is configured into the first state in which the invocation by the virtual machine is supported, the virtual machine may be further configured into the second state, so that the virtual machine performs data processing by using the processor resources of the to-be-configured processor. Thus, on the basis of the strong isolation framework, related hardware attributes of the CPU, for example, various registers, related instructions (such as a pause instruction HLT, a thread synchronization instruction MWAIT, etc.), an interrupt controller of an LAPIC or a peripheral, and the like are all directly passed through to the virtual machine, thereby reducing the exit of the virtual machine and improving the related performance of the virtual machine.

In this embodiment, the manner of configuring the virtual machine into the second state may be set as needed. Optionally, configuring the virtual machine in the physical machine into the second state comprises: establishing an association between the virtual machine in the physical machine and at least one to-be-configured processor; and closing an interrupt trap-out configuration of the virtual machine, and passing through a register in the at least one to-be-configured processor to the virtual machine.

For example, during a startup process of a virtual machine, an association between the currently started virtual machine and at least one to-be-configured processor in a physical machine may be established. For example, one or more to-be-configured processors in a first state are designated to the virtual machine for use. An interrupt trap-out configuration of the virtual machine may be closed, and a register in the at least one to-be-configured processor is passed through to the virtual machine.

The interrupt trap-out may be understood as that a simulation by the software on the physical machine side is needed when the interrupt processing is performed. That is, after the interrupt trap-out is configured, the virtual machine may perform simulation by invoking the software on the physical machine side when the interrupt processing is performed. Therefore, after an interrupt trap-out configuration of the virtual machine is closed, the virtual machine may directly invoke the interrupt controller in the to-be-configured processor having association with the virtual machine to perform interrupt processing, without invoking the software on the physical machine side. The manner in which the registers in the to-be-configured processor are passed through to the virtual machine may be flexibly selected according to needs, which is not limited in this embodiment.

In this embodiment, when the virtual machine is configured into the second state, a predetermined thread synchronization instruction of the virtual machine may or may not be started.

Optionally, configuring the virtual machine in the physical machine into the second state further comprises: starting a predetermined thread synchronization instruction of the virtual machine.

For example, the to-be-configured processor is in a halt state when being idle, waiting to be woken up by a corresponding VCPU thread, for example, the VCPU may wake up a to-be-configured processor having an association therebetween through a non-maskable interrupt (NMI), so that the to-be-configured processor is switched from the idle state to a working state. Therefore, when configuring the virtual machine to the second state, the predetermined thread synchronization instruction of the virtual machine may be started to improve the speed at which the to-be-configured processor switches from the idle state to the working state. The predetermined thread synchronization instruction may be set as needed. For example, the predetermined thread synchronization instruction may include an MWAIT instruction. The PCPU in the state of being predicted for VCPU is in a halt state when being idle, waiting to be woken up by the corresponding VCPU thread through the NMI, and then runs the vepu_enter_guest function to enter the virtual machine; and the virtual machine VCPU forced exit (Guest vCPU kick) may be implemented by using the NMI.

According to the controlling method of the processor provided in this embodiment, the to-be-configured processor is configured into a state in which the invocation by the virtual machine is supported, and the virtual machine is configured into a state of using the processor resources of the to-be-configured processor to perform data processing, so that the virtual machine may directly invoke the configured physical processor to perform data processing, thereby improving data processing speed of the virtual machine and improving performance of the virtual machine.

In some implementations, the method further comprises: after configuring the virtual machine in the physical machine into the second state,
controlling the virtual machine to perform data processing by using processor resources of a target to-be-configured processor, the target to-be-configured processor being a physical processor that is in the first state and has an association with the virtual machine.

The target to-be-configured processor may be a to-be-configured processor having an association with the target virtual machine, and may be a physical processor in a first state.

For example, when the virtual machine has a data processing requirement, the physical processor that has an association with the virtual machine in the physical machine may be determined as the target to-be-configured processor, and the virtual machine is controlled to perform data processing by using the processor resources of the target to-be-configured processor. For example, the virtual machine may process the to-be-processed data by using processor resources such as a register, a predetermined instruction, and/or an interrupt controller in the target processor, without invoking software in the physical machine for simulation.

In the foregoing implementations, the virtual machine may perform data processing by using the processor resources in the target to-be-configured processor. Taking the interrupt controller as an example, because the interrupt controller in the target to-be-configured processor is passed through to the virtual machine, the virtual machine may directly send and receive the interrupt instruction via the interrupt controller in the target to-be-configured processor in the data processing process, thereby improving the sending and receiving speed of the virtual machine interrupt instruction. Optionally: the processor resources comprises an interrupt controller, and controlling the virtual machine to perform data processing by using the processor resources of the target to-be-configured processor comprises: controlling the virtual machine to send and receive an interrupt instruction via the interrupt controller in the target processor.

FIG. 4 is a structural block diagram of an apparatus for controlling a virtual machine according to an embodiment of the present disclosure. The apparatus may be implemented by software and/or hardware, may be configured in an electronic device, typically in a physical machine, and may configure a physical processor in a physical machine by executing a method for controlling a virtual machine. As shown in FIG. 4, the apparatus for controlling a virtual machine provided by the embodiment may comprise an information obtaining module 301, a first determination module 302 and a processor configuring module 303, wherein.

The information obtaining module 301 is configured to obtain, during a physical machine starting process, processor configuration information of the physical machine from a memory of the physical machine, wherein the processor configuration information indicates a to-be-configured processor in the physical machine, and the to-be-configured processor is a physical processor bound to a virtual processor of a virtual machine;

The first determination module 302 is configured to determine the to-be-configured processor based on the processor configuration information; and

The processor configuring module 303 is configured to configure the to-be-configured processor into a first state, when being in the first state, the to-be-configured processor is isolated from the physical machine and supporting an invocation by a virtual machine in the physical machine.

The apparatus for controlling a virtual machine provided by the embodiment, obtains by an information obtaining module, during a physical machine starting process, processor configuration information of the physical machine from a memory of the physical machine, wherein the processor configuration information indicates a to-be-configured processor in the physical machine, and the to-be-configured processor is a physical processor bound to a virtual processor of a virtual machine: by a first determination module, determines the to-be-configured processor based on the processor configuration information; and by a processor configuring module, configures the to-be-configured processor into a first state, when being in the first state, the to-be-configured processor is isolated from the physical machine and supports an invocation by a virtual machine in the physical machine. With The above technical solution of this embodiment, the part of the physical processor in the physical machine is configured into a state in which it is isolated from the physical machine and supports the invocation by the virtual machine in the physical machine. Thus, the virtual machine may directly invoke the configured physical processor for data processing, without simulation by the software in the physical machine. In such a way: the data processing speed of the virtual machine may be improved, and the performance of the virtual machine may be improved.

In the foregoing solution, the processor configuring module 303 may comprise: a processor offline unit, configured to take the to-be-configured processor offline; and an initialization control unit, configured to control, according to virtual machine configuration information stored in the memory of the physical machine, the offline to-be-configured processor to perform initialization to configure the to-be-configured processor into the first state, wherein the offline to-be-configured processor is not registered with a scheduler of the physical machine during initialization.

Further, the apparatus for controlling a virtual machine provided in this embodiment may further comprise: a virtual machine configuring module, configured to, after configuring the to-be-configured processor into the first state, configure the virtual machine in the physical machine into a second state, when being in the second state, the virtual machine performing data processing by using processor resources of the to-be-configured processor.

In above solution, the processor resources may comprise at least one of a register, a predetermined instruction, and an interrupt controller.

In above solution, the virtual machine configuring module may comprise: a relationship establishing unit, configured to establish an association between the virtual machine in the physical machine and at least one to-be-configured processor; and a configuring unit, configured to close an interrupt trap-out configuration of the virtual machine, and pass through a register in the at least one to-be-configured processor to the virtual machine.

In above solution, the virtual machine configuring module further comprises: an instruction starting unit, configured to start a predetermined thread synchronization instruction of the virtual machine.

Further, the apparatus for controlling a virtual machine may further comprise: a data processing module, configured to, after configuring the virtual machine in the physical machine into the second state, control the virtual machine to perform data processing by using processor resources of a target to-be-configured processor, wherein the target to-be-configured processor is a physical processor that is in the first state and has an association with the virtual machine.

In above solution, the processor resources may comprise an interrupt controller, and the data processing module is configured to control the virtual machine to send and receive an interrupt instruction via the interrupt controller in the target processor.

The apparatus for controlling a virtual machine provided in the embodiments of the disclosure may execute the method of controlling a virtual machine provided by any embodiment of the disclosure, and has corresponding functional modules and beneficial effects for executing the method of controlling a virtual machine. For technical details not described in detail in this embodiment, reference may be made to the method of controlling a virtual machine provided in any embodiment of the present disclosure.

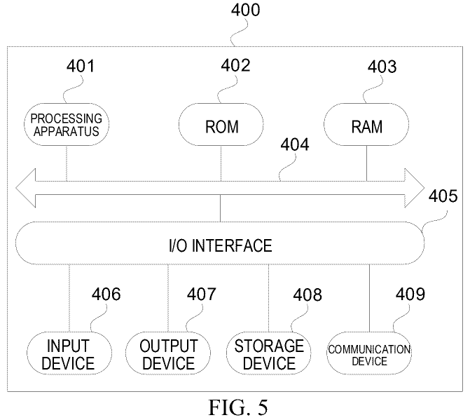

Reference is now made to FIG. 5, which is a schematic structural diagram of an electronic device (for example, a terminal device) 400 suitable for implementing the embodiments of the disclosure. The terminal device in the embodiments of the disclosure may comprise, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (for example, an in-vehicle navigation terminal), and a fixed terminal such as a digital TV, a desktop computer, or the like. The electronic device shown in FIG. 5 is merely an example, and should not impose any limitation on the functions and scope of use of the embodiments of the present disclosure.

As shown in FIG. 5, the electronic device 400 may include a processing device (for example, a central processing unit, a graphics processor, etc.) 401, which may perform various appropriate actions and processing according to a program stored in a read-only memory (ROM) 402 or a program loaded into a random access memory (RAM) 403 from a storage device 408. In the RAM 403, various programs and data required by the operation of the electronic device 400 are also stored. The processing device 401, the ROM 402, and the RAM 403 are connected to each other through a bus 404. Input/output (I/O) interface 405 is also connected to bus 404.

Generally: the following devices may be connected to the I/O interface 405: an input device 406 including, for example, a touch screen, a touchpad, a keyboard, a mouse, a camera, a microphone, an accelerometer, a gyroscope, and the like: an output device 407 including, for example, a liquid crystal display (LCD), a speaker, a vibrator, and the like: a storage device 408 including, for example, a magnetic tape, a hard disk, and the like; and a communication device 409. The communication device 409 may allow the electronic device 400 to communicate wirelessly or wired with other devices to exchange data. While FIG. 5 shows an electronic device 400 having various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure comprise a computer program product comprising a computer program embodied on a non-transitory computer readable medium, the computer program comprising program code for performing the method shown in the flowchart. In such embodiments, the computer program may be downloaded and installed from the network through the communication device 409, or installed from the storage device 408, or from the ROM 402. When the computer program is executed by the processing apparatus 401, the foregoing functions defined in the method of the embodiments of the present disclosure are performed.

It should be noted that the computer-readable medium described above may be a computer readable signal medium, a computer readable storage medium, or any combination of the foregoing. The computer-readable storage medium may be, for example, but not limited to, an electrical, magnetic, optical, electromagnetic, infrared, or semiconductor system, apparatus, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

In some implementations, the client, server may communicate using any currently known or future developed network protocol, such as HTTP (Hyper Text Transfer Protocol), and may be interconnected with any form or medium of digital data communication (e.g., communication network). Examples of communication networks comprise local area networks (“LANs”), wide area networks (“WANs”), internet works (e.g., the Internet), and peer-to-peer networks (e.g., ad hoc peer-to-peer networks), as well as any currently known or future developed networks.

The computer-readable medium described above may be included in the electronic device: or may be separately present without being assembled into the electronic device.

The computer readable medium carries one or more programs, and the one or more programs when executed by the electronic device, causes the electronic device to: obtain, during a physical machine starting process, processor configuration information of the physical machine from a memory of the physical machine, wherein the processor configuration information indicates a to-be-configured processor in the physical machine, and the to-be-configured processor is a physical processor bound to a virtual processor of a virtual machine: determine the to-be-configured processor based on the processor configuration information; and configure the to-be-configured processor into a first state, when being in the first state, the to-be-configured processor is isolated from the physical machine and supporting an invocation by a virtual machine in the physical machine.

Computer program code for performing the operations of the present disclosure may be written in one or more programming languages, including, but not limited to, object-oriented programming languages such as Java, Smalltalk, C++, and conventional procedural programming languages, such as the “C” language or similar programming languages. The program code may execute entirely on a user computer, partially on a user computer, as a stand-alone software package, partially on a user computer and partially on a remote computer, or entirely on a remote computer or server. In the case of a remote computer involved, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that comprises one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. The name of the module does not constitute a limitation on the unit itself in some cases.

The functions described above may be performed, at least in part, by one or more hardware logic components. For example, without limitation, exemplary types of hardware logic components that may be used comprise: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

According to one or more embodiments of the present disclosure, an example 1 provides a method of controlling a virtual machine, comprising:
obtaining, during a physical machine starting process, processor configuration information of the physical machine from a memory of the physical machine, the processor configuration information indicating a to-be-configured processor in the physical machine, and the to-be-configured processor being a physical processor bound to a virtual processor of a virtual machine:
determining the to-be-configured processor based on the processor configuration information; and
configuring the to-be-configured processor into a first state, when being in the first state, the to-be-configured processor being isolated from the physical machine and supporting an invocation by a virtual machine in the physical machine.

According to one or more embodiments, the method of example 2 according to example 1, configuring the to-be-configured processor into the first state comprises:
taking the to-be-configured processor offline; and
controlling, according to virtual machine configuration information stored in the memory of the physical machine, the offline to-be-configured processor to perform initialization to configure the to-be-configured processor into the first state, the offline to-be-configured processor being not registered with a scheduler of the physical machine during initialization.

According to one or more embodiments, the method of example 3 according to example 1 or 2, further comprising, after configuring the to-be-configured processor into the first state:
configuring the virtual machine in the physical machine into a second state, when being in the second state, the virtual machine performing data processing by using processor resources of the to-be-configured processor.

According to one or more embodiments, the method of example 4 according to example 3, the processor resources comprise at least one of a register, a predetermined instruction, and an interrupt controller.

According to one or more embodiments, the method of example 5 according to example 4, configuring the virtual machine in the physical machine into the second state comprises:
establishing an association between the virtual machine in the physical machine and at least one to-be-configured processor; and
closing an interrupt trap-out configuration of the virtual machine, and passing through a register in the at least one to-be-configured processor to the virtual machine.

According to one or more embodiments, the method of example 6 according to example 5, configuring the virtual machine in the physical machine into the second state further comprises: starting a predetermined thread synchronization instruction of the virtual machine.

According to one or more embodiments, the method of example 7 according to example 3, further comprising: after configuring the virtual machine in the physical machine into the second state.
controlling the virtual machine to perform data processing by using processor resources of a target to-be-configured processor, the target to-be-configured processor being a physical processor that is in the first state and has an association with the virtual machine.

According to one or more embodiments, the method of example 8 according to example 7, the processor resources comprise an interrupt controller, and controlling the virtual machine to perform data processing by using the processor resources of the target to-be-configured processor comprises:
controlling the virtual machine to send and receive an interrupt instruction via the interrupt controller in the target processor.

According to one or more embodiments, example 9 provides an apparatus for controlling a virtual machine, comprising:
an information obtaining module configured to obtain, during a physical machine starting process, processor configuration information of the physical machine from a memory of the physical machine, the processor configuration information indicating a to-be-configured processor in the physical machine, and the to-be-configured processor being a physical processor bound to a virtual processor of a virtual machine;
a first determination module configured to determine the to-be-configured processor based on the processor configuration information; and
a processor configuring module configured to configure the to-be-configured processor into a first state, when being in the first state, the to-be-configured processor being isolated from the physical machine and supporting an invocation by a virtual machine in the physical machine.

According to one or more embodiments, example 10 provides an electronic device, comprising: at least one processor; and
a memory storing one or more programs;
the one or more programs, when executed by the one or more processor, causing the one or more processor to perform the method of controlling a virtual machine of any of examples 1 to 8.

According to one or more embodiments, example 11 provides a computer-readable storage medium storing computer instructions which, when executed by a processor, implement the method of controlling a virtual machine of any of examples 1 to 8.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

I/We claim:

1. A method of controlling a virtual machine, comprising:
obtaining, during a physical machine starting process, processor configuration information of the physical machine from a memory of the physical machine, the processor configuration information indicating a to-be-configured processor in the physical machine, and the to-be-configured processor being a physical processor bound to a virtual processor of a virtual machine;
determining the to-be-configured processor based on the processor configuration information; and
configuring the to-be-configured processor into a first state, when being in the first state, the to-be-configured processor being isolated from the physical machine and supporting an invocation by a virtual machine in the physical machine.

2. The method of claim 1, wherein configuring the to-be-configured processor into the first state comprises:
taking the to-be-configured processor offline; and
controlling, according to virtual machine configuration information stored in the memory of the physical machine, the offline to-be-configured processor to perform initialization to configure the to-be-configured processor into the first state, the offline to-be-configured processor being not registered with a scheduler of the physical machine during initialization.

3. The method of claim 1, further comprising, after configuring the to-be-configured processor into the first state:
configuring the virtual machine in the physical machine into a second state, when being in the second state, the virtual machine performing data processing by using processor resources of the to-be-configured processor.

4. The method of claim 3, wherein the processor resources comprise at least one of a register, a predetermined instruction, and an interrupt controller.

5. The method of claim 4, wherein configuring the virtual machine in the physical machine into the second state comprises:
establishing an association between the virtual machine in the physical machine and at least one to-be-configured processor; and
closing an interrupt trap-out configuration of the virtual machine, and passing through a register in the at least one to-be-configured processor to the virtual machine.

6. The method of claim 5, wherein configuring the virtual machine in the physical machine into the second state further comprises:
starting a predetermined thread synchronization instruction of the virtual machine.

7. The method of claim 3, further comprising: after configuring the virtual machine in the physical machine into the second state,
controlling the virtual machine to perform data processing by using processor resources of a target to-be-configured processor, the target to-be-configured processor being a physical processor that is in the first state and has an association with the virtual machine.

8. The method of claim 7, wherein the processor resources comprise an interrupt controller, and controlling the virtual machine to perform data processing by using the processor resources of the target to-be-configured processor comprises:
controlling the virtual machine to send and receive an interrupt instruction via the interrupt controller in the target processor.

9. An electronic device, comprising:
at least one processor; and
a memory communicatively connected to the at least one processor;
wherein the memory stores a computer program executable by the at least one processor, and the computer program is executed by the at least one processor to cause the at least one processor to perform acts comprising:
obtaining, during a physical machine starting process, processor configuration information of the physical machine from a memory of the physical machine, the processor configuration information indicating a to-be-configured processor in the physical machine, and the to-be-configured processor being a physical processor bound to a virtual processor of a virtual machine;
determining the to-be-configured processor based on the processor configuration information; and
configuring the to-be-configured processor into a first state, when being in the first state, the to-be-configured processor being isolated from the physical machine and supporting an invocation by a virtual machine in the physical machine.

10. The electronic device of claim 9, wherein configuring the to-be-configured processor into the first state comprises:
taking the to-be-configured processor offline; and
controlling, according to virtual machine configuration information stored in the memory of the physical machine, the offline to-be-configured processor to perform initialization to configure the to-be-configured processor into the first state, the offline to-be-configured processor being not registered with a scheduler of the physical machine during initialization.

11. The electronic device of claim 9, the acts further comprising, after configuring the to-be-configured processor into the first state:
configuring the virtual machine in the physical machine into a second state, when being in the second state, the virtual machine performing data processing by using processor resources of the to-be-configured processor.

12. The electronic device of claim 11, wherein the processor resources comprise at least one of a register, a predetermined instruction, and an interrupt controller.

13. The electronic device of claim 12, wherein configuring the virtual machine in the physical machine into the second state comprises:
establishing an association between the virtual machine in the physical machine and at least one to-be-configured processor; and
closing an interrupt trap-out configuration of the virtual machine, and passing through a register in the at least one to-be-configured processor to the virtual machine.

14. The electronic device of claim 13, wherein configuring the virtual machine in the physical machine into the second state further comprises:
starting a predetermined thread synchronization instruction of the virtual machine.

15. The electronic device of claim 11, the acts further comprising: after configuring the virtual machine in the physical machine into the second state,
controlling the virtual machine to perform data processing by using processor resources of a target to-be-configured processor, the target to-be-configured processor being a physical processor that is in the first state and has an association with the virtual machine.

16. The electronic device of claim 15, wherein the processor resources comprise an interrupt controller, and controlling the virtual machine to perform data processing by using the processor resources of the target to-be-configured processor comprises:
controlling the virtual machine to send and receive an interrupt instruction via the interrupt controller in the target processor.

17. A non-transitory computer-readable storage medium storing computer instructions which, when executed by a processor, implement the method of controlling a virtual machine comprising:
obtaining, during a physical machine starting process, processor configuration information of the physical machine from a memory of the physical machine, the processor configuration information indicating a to-be-configured processor in the physical machine, and the to-be-configured processor being a physical processor bound to a virtual processor of a virtual machine;
determining the to-be-configured processor based on the processor configuration information; and
configuring the to-be-configured processor into a first state, when being in the first state, the to-be-configured processor being isolated from the physical machine and supporting an invocation by a virtual machine in the physical machine.

18. The non-transitory computer-readable storage medium of claim 17, wherein configuring the to-be-configured processor into the first state comprises:
taking the to-be-configured processor offline; and
controlling, according to virtual machine configuration information stored in the memory of the physical machine, the offline to-be-configured processor to perform initialization to configure the to-be-configured processor into the first state, the offline to-be-configured processor being not registered with a scheduler of the physical machine during initialization.

19. The non-transitory computer-readable storage medium of claim 17, the method further comprising, after configuring the to-be-configured processor into the first state:
configuring the virtual machine in the physical machine into a second state, when being in the second state, the virtual machine performing data processing by using processor resources of the to-be-configured processor.

20. The non-transitory computer-readable storage medium of claim 19, wherein configuring the virtual machine in the physical machine into the second state comprises:
establishing an association between the virtual machine in the physical machine and at least one to-be-configured processor; and
closing an interrupt trap-out configuration of the virtual machine, and passing through a register in the at least one to-be-configured processor to the virtual machine.
